(19) United States
(12) Patent Application Publication
(10) Pub. No.: US 2003/0043263 A1
(43) Pub. Date: Mar. 6, 2003

(54) Diagnostic device using data compression

(76) Inventors: Arkady Glukhovsky, Nesher (IL); Dov Avni, Haifa (IL); Gavriel Meron, Petach Tikva (IL)

Correspondence Address: Eitan, Pearl, Latzer & Cohen-Zede, LLP., Suite 1001, 10 Rockefeller Plaza, New York, NY, 10020, US

(21) Appl. No.: 10/202,626

(22) Filed: Jul. 25, 2002

Related U.S. Application Data
(60) Provisional application No. 60/307,605, filed on Jul. 26, 2001.

(51) Int. Cl. H04N 7/12

(52) U.S. Cl. 348/61; 375/240.01

(57) ABSTRACT

A device, system and method may enable the obtaining of in vivo images from within body lumens or cavities, such as images the gastrointestinal (GI) tract, where the data such as image data is typically transmitted or otherwise sent to a receiving system. The data transmitted, including, for example, image information, is compressed.

### PRIOR PROVISIONAL APPLICATION

The present application claims benefit from prior provisional application No. 60/307,605 entitled “IMAGING DEVICE USING DATA COMPRESSION” and filed on Jul. 26, 2001.

### FIELD OF THE INVENTION

The present invention relates to an in vivo device, system and method such as for imaging the digestive tract; more specifically, to an in vivo device, system and method where information transmitted or sent, is compressed.

### BACKGROUND OF THE INVENTION

Devices and methods for performing in-vivo imaging of passages or cavities within a body, and for gathering information other than or in addition to image information (e.g., temperature information, pressure information), are known in the art. Such devices may include, inter alia, various endoscopic imaging systems and devices for performing imaging in various internal body cavities.

An in-vivo imaging device may include, for example, an imaging system for obtaining images from inside a body cavity or lumen, such as the GI tract. The imaging system may include, for example, an illumination unit, such as a set of light emitting diodes (LEDs), or other suitable light sources. The device may include an imaging sensor and an optical system, which focuses the images onto the imaging sensor. A transmitter and antenna may be included for transmitting the images signals. A receiver/recorder, for example worn by the patient, may record and store image and other data. The recorded data may then be downloaded from the receiver/recorder to a computer or workstation for display and analysis. Such imaging and other devices may transmit data such as image data or other data during a certain period of time. It may be desirable to limit the amount of time spent transmitting image data, and also the bandwidth required for such a transmission. The time spent transmitting limits the amount of image or other data that may be transmitted. Other in-vivo diagnostic units need not transmit by radio waves, for example, image or other data collected may be sent via wire.

Therefore, there is a need for an in-vivo diagnostic device, such as an imaging device, which more efficiently transmits data.

### SUMMARY OF THE INVENTION

An embodiment of the device, system and method of the present invention enables the obtaining of in vivo images from within body lumens or cavities, such as images of the gastrointestinal (GI) tract, where the data such as image data is typically transmitted or otherwise sent to a receiving system According to an embodiment of the invention, the data transmitted, including, for example, image information, is compressed.

### BRIEF DESCRIPTION OF THE DRAWINGS

FIG. 1 shows a schematic diagram of an in vivo imaging system according to one embodiment of the present invention; and

FIG. 2 depicts a series of steps of a method according to an embodiment of the present invention.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Embodiments of the system and method of the present invention are preferably used in conjunction with an imaging system or device such as described in U.S. Pat. No. 5,604,531 to Iddan et al. and/or in application number WO 01/65995 entitled “A Device And System For In Vivo Imaging”, published on 13 Sep. 2001, both of which are hereby incorporated by reference. However, the device, system and method according to the present invention may be used with any device providing imaging or other data from a body lumen or cavity. In alternate embodiments, the system and method of the present invention may be used with devices capturing information other than image information within the human body; for example, temperature, pressure or pH information, information on the location of the transmitting device, or other information.

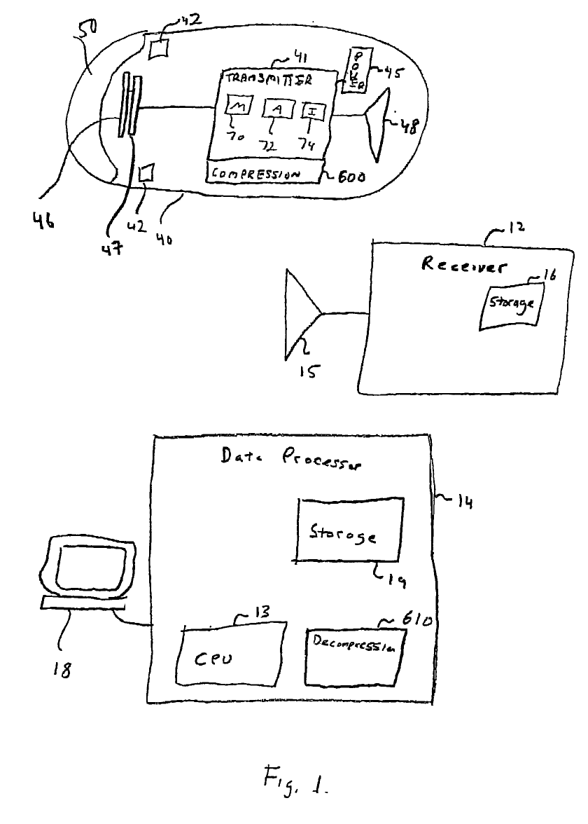

Reference is made to FIG. 1, which shows a schematic diagram of an in vivo imaging system according to one embodiment of the present invention. In an exemplary embodiment, a device 40 is a swallowable capsule capturing images, but may be another sort of device and may collect information other than image information. Typically, device 40 includes at least one sensor such as an imager 46, for capturing images, a processing chip or circuit 47 that processes the signals generated by the imager 46, and one or more illumination sources 42, for example one or more “white LEDs” or any other suitable light source, for illuminating the body lumen. An optical system 50, including, for example, one or more optical elements (not shown), such as one or more lenses or composite lens assemblies (not shown), one or more suitable optical filters (not shown), or any other suitable optical elements (not shown), may aid in focusing reflected light onto the imager 46 and performing other light processing. Processing chip 47 need not be a separate component; for example, processing or a processing chip may be integral to the imager 46. The sensor may be another type of sensor, such as a temperature sensor, a pH sensor, or a pressure sensor.

Device 40 typically includes a transmitter 41, for transmitting image and possibly other information (e.g., control information) to a receiving device, and a compression module 600, for compressing data. The transmitter is typically an ultra low power radio frequency (RF) transmitter with high bandwidth input, possibly provided in chip scale packaging. The transmitter may transmit via an antenna 48. The transmitter may also include circuitry and functionality for controlling the device 40. Typically, the device includes a power source 45, such as one or more batteries. For example, the power source 45 may include silver oxide batteries, lithium batteries, or other electrochemical cells having a high energy density, or the like. Other power sources may be used.

Other components and sets of components may be used. For example, the power source may be an external power source transmitting power to the capsule, and a controller separate from the transmitter 41 may be used.

In one embodiment, the imager 46 is a complementary metal oxide semiconductor (CMOS) imaging camera. The CMOS imager is typically an ultra low power imager and is provided in chip scale packaging (CSP). One suitable CMOS camera is, for example, a “camera on a chip” CMOS imager specified by Given Imaging Ltd. of Israel and designed by Photobit Corp. of California, USA, with integrated active pixel and post processing circuitry. Other types of CMOS imagers may be used. In another embodiment, another imager may be used, such as a CCD imager, or another imager.

Typically, the device 40 is swallowed by a patient and traverses a patient's GI tract, however, other body lumens or cavities may be imaged or examined. The device 40 transmits image and possibly other data to components located outside the patient's body, which receive and process the data. Preferably, located outside the patient's body in one or more locations, are a receiver 12, preferably including an antenna or antenna array 15, for receiving image and possibly other data from device 40, a receiver storage unit 16, for storing image and other data, a data processor 14, a data processor storage unit 19, a data decompression module 610 for decompressing data, and an image monitor 18, for displaying, inter alia, the images transmitted by the device 40 and recorded by the receiver 12. Typically, the receiver 12 and receiver storage unit 16 are small and portable, and are worn on the patient's body during recording of the images. Preferably, data processor 14, data processor storage unit 19 and monitor 18 are part of a personal computer or workstation, which includes standard components such as a processor 13, a memory (e.g., storage 19, or other memory), a, disk drive, and input-output devices, although alternate configurations are possible. In alternate embodiments, the data reception and storage components may be of another configuration. Further, image and other data may be received in other manners, by other sets of components. Typically, in operation, image data is transferred to the data processor 14, which, in conjunction with processor 13 and software, stores, possibly processes, and displays the image data on monitor 18. Other systems and methods of storing and/or displaying collected image data may be used.

Typically, the device 40 transmits image information in discrete portions. Each portion typically corresponds to an image or frame. Other transmission methods are possible. For example, the device 40 may capture an image once every half second, and, after capturing such an image, transmit the image to the receiving antenna. Other capture rates are possible. Typically, the image data recorded and transmitted is digital color image data, although in alternate embodiments other image formats (e.g., black and white image data) may be used. In one embodiment, each frame of image data includes 256 rows of 256 pixels each, each pixel including data for color and brightness, according to known methods. For example, in each pixel, color may be represented by a mosaic of four sub-pixels, each sub-pixel corresponding to primaries such as red, green, or blue (where one primary is represented twice). The brightness of the overall pixel may be recorded by, for example, a one byte (i.e., 0-255) brightness value. Other data formats may be used.

In some embodiments of the device, system and method of the present invention, diagnostic data need not be transmitted, but may be sent via another method, such as via wire. For example, in an endoscope device, an imaging device at one end may send the data via wire to a receiving device.

It may be desirable to limit the amount of time spent transmitting image data, and/or the bandwidth required for such a transmission. Embodiments of the system and method of the present invention compress image and possibly other data before transmission. Since compressed data takes less time to transmit, more data may be transmitted, and more frames of image data may be transmitted per time unit, without increasing the bandwidth of the transmitter. Alternatively, the same amount of data may be transmitted using less bandwidth. Another aspect of the data transmission relates to the transmission systems with limited energy source. In this case smaller amount of bits needed to be transmitted may enable more energy per bit in the transmission. Data other than or in addition to image data may be transmitted and compressed. For example, control information may be compressed. Furthermore, in devices transmitting telemetric information other than image information, such as pressure or pH information, such information may be compressed. In further embodiments, image data need not be transmitted in discrete portions corresponding to images.

In an exemplary embodiment of the present invention, device 40 includes a data compression module 600 for compressing data transmitted from the device 40 and for providing the data to the transmitter 41, possibly via intermediate circuitry. Preferably, data compression module 600 is implemented as part of a microprocessor or ASIC or other micro-computing device and is part of the imager 46 or processing chip 47. In alternate embodiments the functions of the data compression module 600 may be taken up by other structures and may be disposed in different parts of the device 40. For example, the transmitter 41 may include data compression capability, or data compression module 600 may be a stand-alone unit, or may be implemented in software.

In one embodiment, transmitter 41 includes at least a modulator 70 for receiving the video signal from the imager 46, a radio frequency (RF) amplifier 72, and an impedance matcher 74. The modulator converts the input image signal having a cutoff frequency f_{c} of less than 5 MHz to an RF signal having a carrier frequency fᵣ, typically in the range of 1 GHz. While in one embodiment the signal is an analog video signal, the modulating signal may be digital rather than analog. The carrier frequency may be in other bands, e.g. a 400 MHz band. The modulated RF signal has a bandwidth of fₜ. The impedance matcher matches the impedance of the circuit to that of the antenna. Other transmitters or arrangements of transmitter components may be used, utilizing different signal formats and frequency ranges. For example, alternate embodiments may not include a matched antenna or may include a transmitter without a matching circuit. In one embodiment of such an imaging device 40, transmission occurs at a frequency of 434 MHz, using Phase Shift Keying (PSK). In alternate embodiments, other transmission frequencies and methods (such as AM or FM) may be used.

The receiver 12 preferably detects a signal having the carrier frequency fᵣ and the bandwidth f_{c} described hereinabove. The receiver 12 may be similar to those found in televisions or it may be one similar to those described on pages 244-245 of the book Biomedical Telemetry by R. Stewart McKay and published by John Wiley and Sons, 1970. The receiver may be digital or analog. In alternate embodiments, other receivers, responding to other types of signals, may be used.

The receiver 12 preferably includes a data decompression module 610 for decompressing data received from the device 40. In exemplary embodiment data decompression module 610 is a microprocessor or other micro-computing device and is part of the receiver 12. In alternate embodiments the functions of the data decompression (decoding) module 610 may be taken up by other structures and may be disposed in different parts of the system; for example, data decompression module 610 may be implemented in software and/or be part of data processor 14. The receiver 12 may receive compressed data without decompressing the data and store the compressed data in the receiver storage unit 16. The data may be later decompressed by, for example data processor 14.

Preferably, the transmitter 41 provides overall control of the device 40; in alternate embodiments control may be provided by other modules. Preferably, the data compression module 600 interfaces with the transmitter 41 to receive and compress image data; other units may provide other data to data compression module 600. In addition, the data compression module 600 may provide the transmitter 41 with information such as, for example, start or stop time for the transfer of image data from the data compression module 600 to the transmitter 41, the length or size of each block of such image data, and the rate of frame data transfer. The interface between the data compression module 600 and the transmitter 41 may be handled, for example, by the data compression module 600. Typically, the data compression module 600 compresses image information in discrete portions. Each portion typically corresponds to an image or frame. Other compression methods or sequences are possible, and other units of compression and transmission are possible. One of the other possibilities to compress the image data is to compare the subsequent images, and to transmit only difference between these images rather that each image. Assuming that in most cases the subsequent images are similar, the difference between the images will contain much less information than the image itself.

In alternate embodiments, the data exchanged between the data compression module 600 and the transmitter 41 may be different, and in different forms. For example, size information need not be transferred. Furthermore, in embodiments having alternate arrangements of components, the interface and protocol between the various components may also differ. For example, in an embodiment where a data compression capability is included in the transmitter 41 and the imager 46 transfers un-compressed data to the transmitter 41, no start/stop or size information may be transferred.

The data compression module 600 and data decompression module 610 may use various data compression formats and systems. For example, the data may be compressed and decompressed according to the various JPEG or MPEG formats and standards; other formats may be used. Compression formats used may include compression formats where some data is lost during compression and compression formats where data is not lost during compression. Typically, the data compression module 600 and decompression module 610 include circuitry and/or software to perform such data compression. For example, if the data compression module 600 or decompression module 610 are implemented as a computer on a chip or ASIC, data compression module 600 or decompression module 610 may include a processor operating on firmware which includes instructions for a data compression algorithm. If data decompression module 610 is implemented as part of data processor 14 and/or processor 13, the decompression may be implemented as part of a software program.

The amount of imager data to be sent may be, for example, over 1.35 Megabits per second. Compression may significantly reduce this amount. After compression, and before transmission, randomization may occur (performed, for example, by the transmitter 41). Namely, the occurrence of the digital signals (“0” and “1”) may be randomized so that transmission is not impeded by a recurring signal of one type.

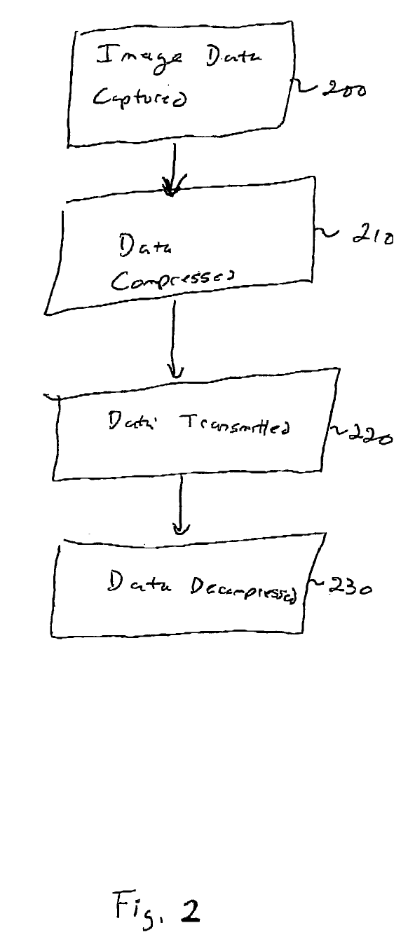

FIG. 2 depicts a series of steps of a method according to an embodiment of the present invention. Referring to FIG. 2, in step 200, an in-vivo device, such as a swallowable capsule, captures image data. Typically, an imager within the device captures image data of a gastrointestinal tract, but other image data may be captured, for example, image data from other body lumens or cavities. Data other than or in addition to image data may be captured.

In step 210, the image data is compressed. The image data may be first loaded or transferred from the imager, or, alternately, compressed at the imager. Data other than or in addition to image data may be compressed.

In step 220, the data is transmitted to a receiver. Typically, the data, such as image data, is transmitted using radio waves (RF channel) to a receiver external to the body, but other methods may be used. In alternate embodiments, the image or other data may be sent by other methods, such as by wire.

In step 230, the data is decompressed. Image data may be, for example, displayed. Alternately, the image data need not be decompressed, but may be stored for later use.

Other steps or series of steps may be used.

While the invention has been described with respect to a limited number of embodiments, it will be appreciated that many variations, modifications and other applications of the invention may be made.

Embodiments of the present invention may include apparatuses for performing the operations herein. Such apparatuses may be specially constructed for the desired purposes (e.g., a “computer on a chip” or an ASIC), or may comprise general purpose computers selectively activated or reconfigured by a computer program stored in the computers. Such computer programs may be stored in a computer readable storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions.

The processes presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems appears from the description herein. In addition, embodiments of the present invention are not described with reference to any particular programming language. It will be appreciated that a variety of programming languages may be used to implement the teachings of the invention as described herein.

Unless specifically stated otherwise, as apparent from the discussions herein, it is appreciated that throughout the specification discussions utilizing terms such as “processing”, “computing”, “calculating”, “determining”, or the like, typically refer to the action and/or processes of a computer or computing system, or similar electronic computing device (e.g., a “computer on a chip” or ASIC), that manipulate and/or transform data represented as physical, such as electronic, quantities within the computing system's registers and/or memories into other data similarly represented as physical quantities within the computing system's memories, registers or other such information storage, transmission or display devices.

The data compression methods described above may be lossless or lossy. Losseless data compression enables precise (with no distortion) decoding of the compressed data. The compression ratio of loseless methods is however limited. Lossy compression methods do not enable precise decoding of the compressed information. However the compression ration of lossy methods may be much higher than of the loseless method. In many cases the data distortion of the lossy methods is non-significant, and the compress ratio is high.

Popular compression algorithms, such as JPEG and MPEG have an option to operate according to either loseless or lossy scheme.

Without limitation of generality, the description of data compression schemes above may be applicable both to loseless and to lossy methods.

It will be appreciated by persons skilled in the art that the present invention is not limited to what has been particularly shown and described hereinabove. Rather the scope of the present invention is defined only by the claims, which follow:

1. An in-vivo device comprising:
a sensor; and
a data compression unit.

2. The in-vivo device of claim 1, wherein the sensor is an imager.

3. The in-vivo device of claim 2, wherein the imager includes a CMOS.

4. The in-vivo device of claim 2, wherein the data compression unit is configured to accept image data from the imager and compress the image data.

5. The in-vivo device of claim 2, wherein the data compression unit is configured to accept image data from the imager in units of one frame and compress the image data in units of one frame.

6. The in-vivo device of claim 1 comprising a light source.

7. The in-vivo device of claim 1, wherein the data compression unit includes JPEG compression capability.

8. The in-vivo device of claim 1, wherein the data compression unit includes MPEG compression capability.

9. The in-vivo device of claim 1, wherein the in-vivo device is a swallowable capsule.

10. The in-vivo device of claim 1, wherein the in-vivo device is configured for imaging the gastrointestinal tract.

11. The in-vivo device of claim 1, comprising an RF transmitter.

12. The in-vivo device of claim 11, wherein the data compression unit provides compressed data to the transmitter.

13. A method of operating an in-vivo device including a sensor, the method comprising:
accepting data from the sensor; and
compressing the data to form compressed data.

14. The method of claim 13, comprising transmitting the compressed data.

15. The method of claim 13, comprising transmitting the compressed data via RF channel.

16. The method of claim 13, wherein the sensor includes an imager.

17. The method of claim 13, wherein the sensor includes a CMOS.

18. The method of claim 13, wherein the data accepted from the sensor is image data.

19. The method of claim 16, comprising:
accepting image data from the sensor in units of one frame; and
compressing the image data in units of one frame.

20. The method of claim 13, comprising compressing the data in a JPEG format.

21. The method of claim 13, comprising compressing the data in an MPEG format.

22. The method of claim 13, wherein the in-vivo device is a swallowable capsule.

23. The method of claim 13, comprising imaging the gastrointestinal tract.

24. The method of claim 13, comprising decompressing the data.

25. The method of claim 13, comprising displaying data as image data.

26. An in-vivo device comprising:
a sensor means for sensing in-vivo information; and
a data compression means for compressing data.

27. The device of claim 26 comprising a transmission means for transmitting data.

28. The device of claim 26 wherein the sensor means includes at least an imaging means.

29. An ingestible capsule comprising:
a sensor capable of collecting in-vivo data;
an RF transmitter; and
a data compression unit.

30. An in-vivo imaging device comprising:
an imager;
a transmitter; and
a data compression unit capable of receiving data from the imager and compressing the data for transmission.

31. A method of operating an in-vivo device including an imager, the method comprising:
transferring image data from the imager to a compression unit;
compressing the data; and
transmitting the compressed data.

32. A method of operating an swallowable in-vivo device, the method comprising:
collecting in-vivo data;
transferring the data to a compression unit;
compressing the data (; and
sending the compressed data via RF channel.
